(19) United States
(12) Patent Application Publication
(10) Pub. No.: US 2008/0256802 A1
(43) Pub. Date: Oct. 23, 2008

(54) Array of razor cartridges

(76) Inventors: William Thomas O'Connor, Londonderry, NH (US); John Prudden, Essex, MA (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 11/788,539

(22) Filed: Apr. 20, 2007

(51) Int. Cl. B26B 21/00

(52) U.S. Cl. 30/50

(57) ABSTRACT

An array of razor cartridges is provided. The array includes a first shaving cartridge having a first casing and a plurality of shaving blades secured within the first casing. The first frame has a first configuration. The first frame is secured to the first shaving cartridge to form a first razor cartridge. The array also includes a second shaving cartridge having a second casing and a plurality of shaving blades secured within the second casing. The second casing is identical to the first casing. A second frame having a second configuration is secured to the second shaving cartridge to from a second razor cartridge. The second configuration of the second cartridge is different than said first configuration of the first cartridge.

### FIELD OF THE INVENTION

The present invention is directed to an array of razor cartridge configurations.

### BACKGROUND OF THE INVENTION

Razor cartridges are designed to cut or shave a user's hair. The cartridges include one or more blades having at least one sharpened edge. The blades are held in place by what is commonly referred to as a housing. The housing typically includes one or more features to improve the overall shaving experience. Such common features include a guard which is located on the housing in front of the blades and a cap which is located behind the blades. The guard often includes an elastomeric member and the cap often includes a lubricating strip of some kind.

On the market today are a vast number of razor cartridge configurations. Some have big guards, some have smaller guards, some guards have elastomeric members with fins while others have elastomeric members with depressions and some guards have lubricating strips. Similarly some razor cartridges have big caps, some have smaller caps, and some caps have a lubricating strip.

In order to meet the demands of consumers, numerous designs have been configured. The numerous designs come at a cost however as much effort is spent on each design. That is, each cartridge is designed from scratch such that none of the molds and production equipment used to make one cartridge can be utilized to make a cartridge of a different design. For example, the molds and production equipment used to make the Gillette™ Mach3™ razor cartridge could not be used to make the Gillette™ Fusion™ razor cartridge. This results in higher cost as product design, molding and production equipment cost have to be done separately for each product. Thus, there is a need for in alternative design to reduce cost and effort to produce different razor cartridges to meet the demands of consumers.

If one could start with a standard casing that houses the blades and have the flexibility to add frames of various configurations to the standard casing a large portion of the cost and effort could be eliminated.

### SUMMARY OF THE INVENTION

In accordance with the present invention an array of razor cartridges is provided. The array comprises a first shaving cartridge comprised of a first casing and a plurality of shaving blades secured within the first casing. The first casing comprises a guard bar and a cap bar. A first frame having a first configuration is secured to the first shaving cartridge to form a first razor cartridge. The array also comprises a second shaving cartridge comprised of a second casing and a plurality of shaving blades secured within the second casing. The second casing comprises a guard bar and a cap bar. The second casing is identical to the first casing. A second frame having a second configuration is secured to the second shaving cartridge to form a second razor cartridge. The second configuration of the second frame is different than the first configuration of the first frame.

In accordance with another aspect of the present invention an array of razor cartridges is provided. The array comprises a first shaving cartridge comprised of a first casing and a plurality of shaving blades secured within the first casing. The first casing comprises a guard bar and a cap bar. A first frame having a first configuration is secured to the first shaving cartridge to form a first razor cartridge. The array also comprises a second shaving cartridge comprised of a second casing and a plurality of shaving blades secured within the second casing. The second casing comprises a guard bar and a cap bar. The second shaving cartridge is identical to the first shaving cartridge. A second frame having a second configuration is secured to the second shaving cartridge to form a second razor cartridge. The second configuration of the second frame is different than the first configuration of the first frame.

The first and second shaving cartridges may comprise two, three, four, five, six or more shaving blades.

The first frame comprises a first guard and the second frame comprises a second guard different from the first guard.

The first frame comprises a first cap and the second frame comprises a second cap different from the first cap.

The first frame comprises a first footprint and the second frame comprises a second footprint different from the first footprint.

The first frame comprises a first perimeter and the second frame comprises a second perimeter different from the first perimeter.

In accordance with another aspect of the present invention an array of razor cartridges is provided. The array comprises a first shaving cartridge comprised of a first casing and a plurality of shaving blades secured within the first casing. The first casing comprises a guard bar and a cap bar. A first frame having a first configuration is secured to the first shaving cartridge to form a first razor cartridge. The array also comprises a second shaving cartridge comprised of a second casing and a plurality of shaving blades secured within the second casing. The second casing comprises a guard bar and a cap bar. The second casing is identical to the first casing. A second frame having a second configuration is secured to the second shaving cartridge to form a second razor cartridge. The second configuration of the second frame is different than the first configuration of the first frame. The array also comprises a third shaving cartridge comprised of a third casing and a plurality of shaving blades secured within the third casing. The third casing comprises a guard bar and a cap bar. The third casing is identical to the first and second casings. A third frame having a third configuration is secured to the third shaving cartridge. The third configuration of the third frame is different than the configurations of the first and second frames.

In accordance with another aspect of the present invention an array of razor cartridges is provided. The array comprises a first shaving cartridge comprised of a first casing and a plurality of shaving blades secured within the first casing. The first casing comprises a guard bar and a cap bar. A first frame having a first configuration is secured to the first shaving cartridge to form a first razor cartridge. The array also comprises a second shaving cartridge comprised of a second casing and a plurality of shaving blades secured within the second casing. The second casing comprises a guard bar and a cap bar. The second shaving cartridge is identical to the first shaving cartridge. A second frame having a second configuration is secured to the second shaving cartridge to form a second razor cartridge. The second configuration of the second frame is different than the first configuration of the first frame. The array also comprises a third shaving cartridge comprised of a third casing and a plurality of shaving blades secured within the third casing. The third casing comprises a guard bar and a cap bar. The third shaving cartridge is identical to the first and second shaving cartridges. A third frame having a third configuration is secured to the third shaving cartridge. The third configuration of the third frame is different than the configurations of the first and second frames.

### BRIEF DESCRIPTION OF THE DRAWINGS

While the specification concludes with claims particularly pointing out and distinctly claiming the subject matter which is regarded as forming the present invention, it is believed that the invention will be better understood from the following description taken in conjunction with the accompanying drawings.

FIG. 1 is a view of an array of razor cartridges of the present invention.

FIG. 2 is a perspective view of a shaving cartridge of the present invention.

FIG. 3 is a top plan view of the casing of FIG. 2 with the blades removed.

FIG. 4 is a perspective view of the first frame.

FIG. 5 is a perspective view of the second frame.

FIG. 6 is a view of an array of razor cartridges of the present invention.

### DETAILED DESCRIPTION OF THE INVENTION

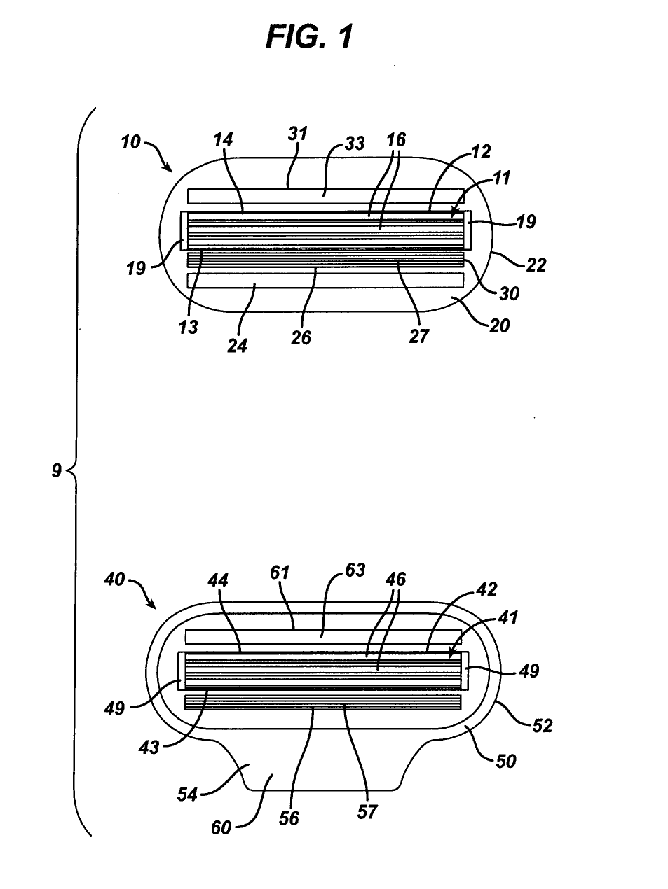

Referring now to FIG. 1, there is shown an array 9 of razor cartridges comprising first razor cartridge 10 and second razor cartridge 40. The first razor cartridge 10 comprises a first shaving cartridge 11 and a first frame 20 secured to the first shaving cartridge 11. The first shaving cartridge 11 comprises a first casing 12 and a plurality of shaving blades 16 secured within the first casing 12. The first casing 12 has a guard bar 13 and a cap bar 14. The guard bar 13 contacts the skin in front of or before the blades 16 and the cap bar 14 contacts the skin behind or after the blades 16. A pair of clips 19 secure blades 16 within first casing 12. The first casing 12 has a first configuration. The first shaving cartridge 11 has a first configuration. The first frame 20 has a first configuration.

The second razor cartridge 40 comprises a second shaving cartridge 41 and a second frame 50 secured to the second shaving cartridge 41. The second shaving cartridge 41 comprises a second casing 42 and a plurality of shaving blades 46 secured within the second casing 42. The second casing 42 has a guard bar 43 and a cap bar 44. The guard bar 43 contacts the skin in front of or before the blades 46 and the cap bar 44 contacts the skin behind or after the blades 46. A pair of clips 49 secure blades 46 within second casing 42. The second casing 42 has a second configuration. The second configuration of the second casing 42 is identical to the first configuration of the first casing 12. The second shaving cartridge 41 has a second configuration. The second frame 50 has a second configuration. The second configuration of the second frame 50 is different than first configuration of the first frame 20.

The first casing 12 and the second casing 42 form the casings of the present invention. The first casing 12 and the second casing 42 are identical to each other. To meet the demands of numerous consumers simply supplying a single razor cartridge that is identical would not be appealing to all consumers. Thus, to meet the demands of consumers the present invention utilizes identical casings as the foundation for the shaving cartridges and secures to them unique frames to form unique razor cartridges. The unique frames can be customized to meet the various demands of consumers.

The first shaving cartridge 11 and the second shaving cartridge 41 are shown to each have five blades. The number of blades in the first and second shaving cartridges can be selected to deliver the desired shaving. For example, the first and second shaving cartridges may have two, three, four, five, six or more blades.

As can be seen in FIG. 1 the configuration of the first frame 20 is different than the configuration of the second frame 50. The shape of the perimeter 22 of the first frame 20 is different than the shape of the perimeter 52 of the second frame 50. The size and shape of the lubricating member 24 of first frame 20 is different than the size and shape of the lubricating member 54 of the second frame 50. The size and shape of the elastomeric member 26 comprising elastomeric fins 27 of first frame 20 is different than the size and shape of the elastomeric member 56 comprising elastomeric fins 57 of second frame 50. Any one of the above differences results in a unique footprint for first frame 20 that is different from the unique footprint for second frame 50. The footprint being the impression one would see if the frame were to be pressed into a formable mass such as clay and then removed. What is left after the frame is removed would be the frame's footprint. There are other differences in the footprints of the first and second frames with only these being provided as illustrative of the concept.

The first frame 20 has a first guard 30 and a first cap 31. The first guard 30 contacts the skin in front of or before the blades 16 and the first cap 31 contacts the skin behind or after the blades 16. The first guard 30 often includes an elastomeric member and lubricating member as mentioned earlier. The first cap 31 often includes a lubricating member such as lubricating member 33.

The second frame 50 has a second guard 60 and a second cap 61. The second guard 60 contacts the skin in front of or before the blades 46 and the second cap 61 contacts the skin behind or after the blades 46. The second guard 60 often includes an elastomeric member and lubricating member as mentioned earlier. The second cap 61 often includes a lubricating member such as lubricating member 63.

The second guard 60 of second frame 50 is different than first guard 30 of first frame 20. The second cap 61 of second frame 50 is different than the first cap 31 of first frame 20.

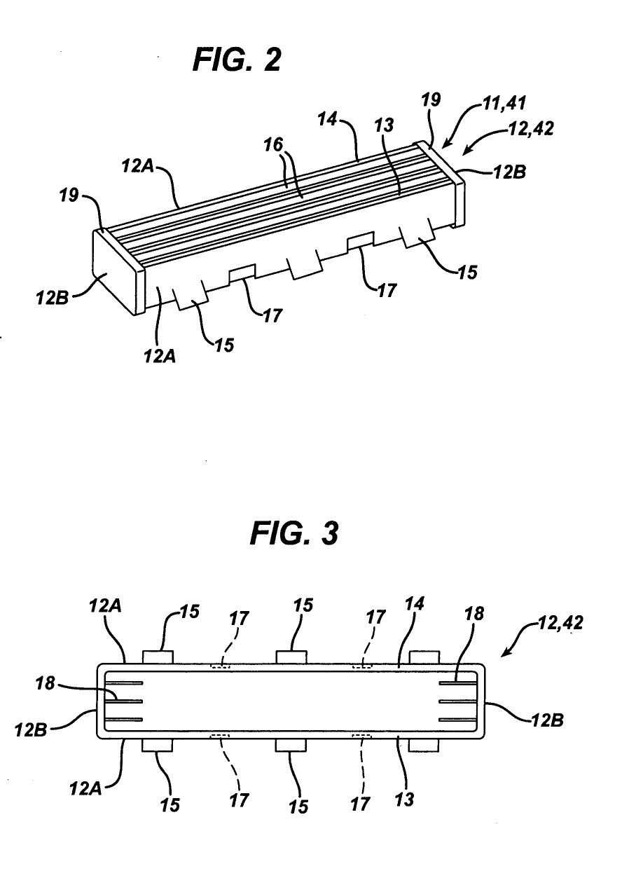

Referring now to FIGS. 2 and 3, there is shown a shaving cartridge 11, 41 and a casing 12, 42, respectively. As the first casing 12 and the second casing 42 are identical only one casing will be illustrated. The casing 12, 42 comprises a guard bar 13 and a cap bar 14. A plurality of blades 16 are secured within casing 12, 42 with a pair of clips 19 to form a shaving cartridge 11, 41. While blades 16 are shown secured within casing 12, 42 with clips 19, other methods may be utilized to secure blades 16 within casing 12, 42. The casing 12, 42 comprises a pair of opposing side walls 12A and a pair of opposing end walls 12B. Opposing side walls 12A each comprise a number of projections 15 and a number of recesses 17. The side walls 12A and the end walls 12B define an opening in which blades 16 are positioned. As can be seen in FIG. 3 casing 12, 42 also comprises a plurality of springs 18 extending from each end wall 12B. Each spring 18 supports a blade, (not shown in FIG. 3).

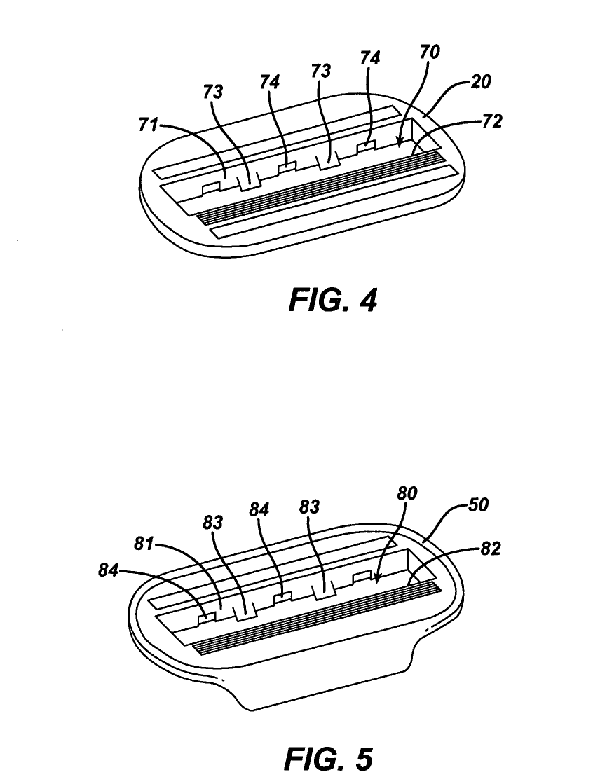

Referring now to FIG. 4 there is shown a perspective view of first frame 20. First frame 20 has an opening 70 to receive shaving cartridge 11, 41. A pair of opposing walls 71, 72 define a portion of opening 70. Wall 71 includes a number of projections 73 and a number of openings 74. Projections 73 engage with recesses 17 on shaving cartridge 11, 41 while projections 15 on shaving cartridge 11, 41 engage with recesses 74 on wall 71 to join shaving cartridge 11, 41 to first frame 20 to form first razor cartridge 10, shown in FIG. 1. Wall 72 also has a number of projections and openings similar to those found in wall 71.

Referring now to FIG. 5 there is shown a perspective view of second frame 50. Second frame 50 has an opening 80 to receive shaving cartridge 11, 41. A pair of opposing walls 81, 82 define a portion of opening 80. Wall 81 includes a number of projections 83 and a number of recesses 84. Projections 83 engage with recesses 17 on shaving cartridge 11, 41 while projections 15 on shaving cartridge 11, 41 engage with recesses 84 on wall 81 to join shaving cartridge 11, 41 to second frame 50 to form second razor cartridge 40, shown in FIG. 1. Wall 82 also has a number of projections and openings similar to those found in wall 81.

In the array shown in FIG. 1, the first shaving cartridge is identical to the second shaving cartridge. That is, the other elements added to the first and second identical casings are also identical. Such elements include the clips and blades.

In some arrays it may be advantageous to utilize identical casings but not utilize identical blades. In other arrays it may be advantageous to utilize identical casings but not utilize identical clips. These are just a few examples of alternative arrays that still take advantage of the identical casings but allow for some flexibility in the shaving cartridge. Such flexibility enables the tailoring of razor cartridges to meet the demands of consumers.

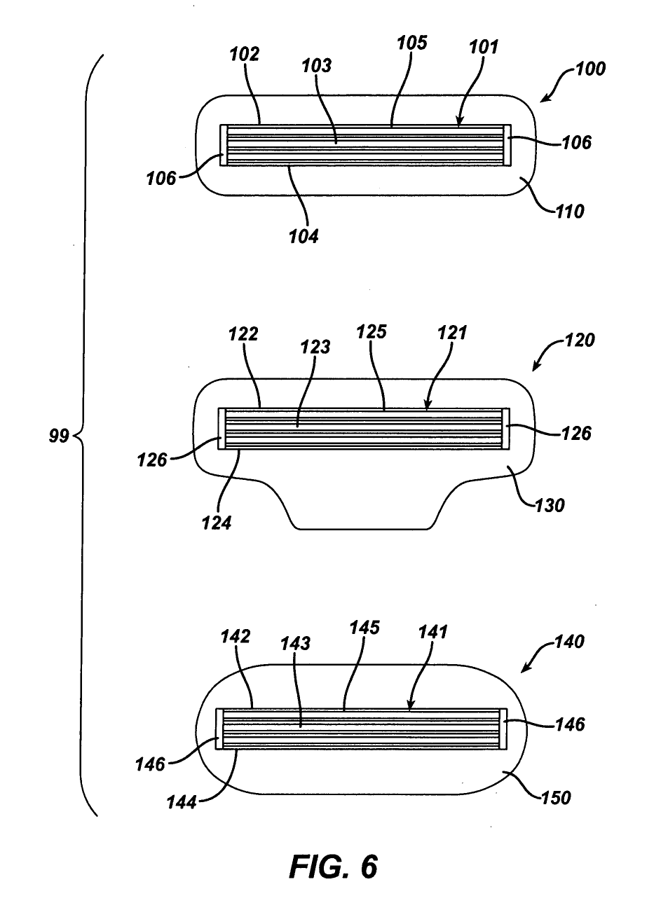

Referring now to FIG. 6, there is shown an array 99 of razor cartridges comprising first razor cartridge 100, second razor cartridge 120 and third razor cartridge 140.

The first razor cartridge 100 comprises a first shaving cartridge 101 and a first frame 110 secured to the first shaving cartridge 101. The first shaving cartridge 101 comprises a first casing 102 and a plurality of shaving blades 103 secured within the first casing 102. The first casing 102 has a guard bar 104 and a cap bar 105. A pair of clips 106 secure blades 103 within first casing 102. The first casing 102 has a first configuration. The first shaving cartridge 101 has a first configuration. The first frame 110 has a first configuration.

The second razor cartridge 120 comprises a second shaving cartridge 121 and a second frame 130 joined to the second shaving cartridge 121. The second shaving cartridge 121 comprises a second casing 122 and a plurality of shaving blades 123 secured within the second casing 122. The second casing 122 has a guard bar 124 and a cap bar 125. A pair of clips 126 secure blades 123 within second casing 122. The second casing 122 has a second configuration. The second casing 122 is identical to the first casing 102. The second shaving cartridge 121 has a second configuration. The second shaving cartridge 121 is identical to the first shaving cartridge 101. The second frame 130 has a second configuration. The second configuration of the second frame 130 is different than first configuration of the first frame 110.

The third razor cartridge 140 comprises a third shaving cartridge 141 and a third frame 150 joined to the third shaving cartridge 141. The third shaving cartridge 141 comprises a third casing 142 and a plurality of shaving blades 143 secured within the third casing 142. The third casing 142 has a guard bar 144 and a cap bar 145. A pair of clips 146 secure blades 143 within third casing 142. The third casing 142 has a third configuration. The third casing 142 is identical to the first casing 102 and the second casing 122. The third shaving cartridge 141 has a third configuration. The third shaving cartridge 141 is identical to the first shaving cartridge 101 and the second shaving cartridge 121. The third frame 150 has a third configuration. The third configuration of the third frame 150 is different than both the first configuration of the first frame 110 and the second configuration of the second frame 130.

The arrays illustrated in FIGS. 1 and 6 are comprised of two and three razor cartridges, respectively. However, the present invention is not limited to an array of two or three razor cartridges. For example, the array may comprise four or more razor cartridges.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An array of razor cartridges, said array comprising:
a first shaving cartridge comprising a first casing and a plurality of shaving blades secured within said first casing, said first casing comprising a guard bar and a cap bar;
a first frame having a first configuration secured to said first shaving cartridge to form a first razor cartridge;
a second shaving cartridge comprising a second casing and plurality of shaving blades secured within said second casing, said second casing comprising a guard bar and a cap bar, said second casing being identical to said first casing; and
a second frame having a second configuration secured to said second shaving cartridge to form a second razor cartridge, said second configuration being different than said first configuration.

2. The array of claim 1 wherein said first shaving cartridge and said second shaving cartridge each comprise two shaving blades.

3. The array of claim 1 wherein said first shaving cartridge and said second shaving cartridge each comprise three shaving blades.

4. The array of claim 1 wherein said first shaving cartridge and said second shaving cartridge each comprise four shaving blades.

5. The array of claim 1 wherein said first shaving cartridge and said second shaving cartridge each comprise five shaving blades.

6. The array of claim 1 wherein said first frame comprises a first guard and said second frame comprises a second guard different from said first guard.

7. The array of claim 1 wherein said first frame comprises a first cap and said second frame comprises a second cap different from said first cap.

8. The array of claim 1 wherein said first frame comprises a first footprint and said second frame comprises a second footprint which is different from said first footprint.

9. The array of claim 1 wherein said first frame comprises a first perimeter and said second frame comprises a second perimeter which is different from said first perimeter.

10. An array of razor cartridges, said array comprising:
a first shaving cartridge comprising a first casing and a plurality of first shaving blades secured within said first casing, said first casing comprising a guard bar and a cap bar;
a first frame having a first configuration secured to said first shaving cartridge to form a first razor cartridge;
a second shaving cartridge comprising a second casing and plurality of second shaving blades secured within said second casing, said second casing comprising a guard bar and a cap bar, said second shaving cartridge being identical to said first shaving cartridge; and
a second frame having a second configuration secured to said second shaving cartridge to form a second razor cartridge, said second configuration being different than said first configuration.

11. The array of claim 10 wherein said first frame comprises a first guard and said second frame comprises a second guard different from said first guard.

12. The array of claim 10 wherein said first frame comprises a first cap and said second frame comprises a second cap different from said first cap.

13. The array of claim 10 wherein said first frame comprises a first footprint and said second frame comprises a second footprint which is different from said first footprint.

14. The array of claim 10 wherein said first frame comprises a first perimeter and said second frame comprises a second perimeter which is different from said first perimeter.

15. An array of razor cartridges, said array comprising:
a first shaving cartridge comprising a first casing and a plurality of shaving blades secured within said first casing, said first casing comprising a guard bar and a cap bar;
a first frame having a first configuration secured to said first shaving cartridge to form a first razor cartridge;
a second shaving cartridge comprising a second casing and a plurality of shaving blades secured within said second casing, said second casing comprising a guard bar and a cap bar, said second casing being identical to said first casing;
a second frame having a second configuration secured to said second shaving cartridge to form a second razor cartridge, said second configuration being different than said first configuration;
a third shaving cartridge comprising a third casing and a plurality of shaving blades secured within said third casing, said third casing comprising a guard bar and a cap bar, said third casing being identical to said first and second casings; and
a third frame having a third configuration secured to said third shaving cartridge to form a third razor cartridge, said third configuration being different than said first and second configurations.

16. An array of razor cartridges, said array comprising:
a first shaving cartridge comprising a first casing and a plurality of shaving blades secured within said first casing, said first casing comprising a guard bar and a cap bar;
a first frame having a first configuration secured to said first shaving cartridge to form a first razor cartridge;
a second shaving cartridge comprising a second casing and a plurality of shaving blades secured within said second casing, said second casing comprising a guard bar and a cap bar, said second shaving cartridge being identical to said first shaving cartridge;
a second frame having a second configuration secured to said second shaving cartridge to form a second razor cartridge, said second configuration being different than said first configuration;
a third shaving cartridge comprising a third casing and a plurality of shaving blades secured within said third casing, said third casing comprising a guard bar and a cap bar, said third shaving cartridge being identical to said first and second shaving cartridges; and
a third frame having a third configuration secured to said third shaving cartridge to form a third razor cartridge, said third configuration being different than said first and second configurations.
